(19) United States
(12) Patent Application Publication
(10) Pub. No.: US 2008/0240266 A1
(43) Pub. Date: Oct. 2, 2008

(54) Arrangements for monitoring and controlling a transmission path

(76) Inventors: Keith R. Tinsley, Beaverton, OR (US); Chaitanya Sreerama, Hillsboro, OR (US); Stephen H. Hall, Forest Grove, OR (US); Michael E. Deisher, Hillsboro, OR (US); Kevin Slattery, Hillsboro, OR (US); Kyungtae Han, Hillsboro, OR (US)

Correspondence Address: SCHUBERT, OSTERRIEDER & NICKELSON, PLLC;c/o Intellevate, LLC, P.O. BOX 52050, MINNEAPOLIS, MN, 55402, US

(21) Appl. No.: 11/731,037

(22) Filed: Mar. 30, 2007

(51) Int. Cl. H04K 1/10

(52) U.S. Cl. 375/260

(57) ABSTRACT

In one embodiment of the present disclosure, a method for improving communication between a transmitter and a receiver is disclosed. The method can include receiving a first signal having a first power level over a first path, receiving a second signal having a second power level over a second path wherein the first path is different than the second path. The method can compare the first power level with the second power and determine a difference between the first power level and the second power level. The method can also adjusting a parameter in the system to reduce the difference in power levels between the first and second signals compensating for interference cause by many sources.

### FIELD OF DISCLOSURE

The present disclosure is related to the field of electronics and more particularly to the field of monitoring and controlling operation of a transmission path.

### BRIEF DESCRIPTION OF THE DRAWINGS

Aspects of the disclosure will become apparent upon reading the following detailed description and upon reference to the accompanying drawings in which, like references may indicate similar elements:

FIG. 1 depicts a block diagram of a transmission path monitor/control system;

FIG. 2 depicts a block diagram of a transmission path monitor/control system; and

FIG. 3 is a flow diagram for monitoring and controlling a transmission path.

### DETAILED DESCRIPTION OF EMBODIMENTS

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims. The descriptions below are designed to make such embodiments obvious to a person of ordinary skill in the art.

While specific embodiments will be described below with reference to particular configurations of hardware and/or software, those of skill in the art will realize that embodiments of the present disclosure may advantageously be implemented with other equivalent hardware and/or software systems. Aspects of the disclosure described herein may be stored or distributed on computer-readable media, including magnetic and optically readable and removable computer disks, as well as distributed electronically over the Internet or over other networks, including wireless networks. Data structures and transmission of data (including wireless transmission) particular to aspects of the disclosure are also encompassed within the scope of the disclosure.

Transmission paths such as wireless paths or physical conductors are an integral part of electronic equipment. Physical conductors such as copper traces of a circuit board commonly have imperfections that cause radio frequency interference (RFI) and/or electromagnetic interference (EMI). Alternately, in a wireless transmission path RFI and EMI are common. For example, a clock or a phase locked loop can generate noise that will interfere with circuit operation. In all such cases, the system will under perform at the desired speeds as electromagnetic interference becomes prevalent in physical transmission lines due to impedance mismatches and coupling of the RFI EMI into the physical conductors. When such problems occur on a transmission path, the system may not be able to reliably transit data and receive data at the required speeds.

In some configurations such as a wireless configuration the transmission path can be referred to as a channel. In this wireless transmission path there can be many sources of interference such as a clock signal that couples into the receiver. For example, a phase locked loop or a voltage controlled oscillator near a low noise amplifier in a receiver can produce noise making it difficult for the receiver to receive the relatively low signal level that is being received by the antennae.

Traditionally, the design and manufacture of sophisticated communication systems must be tightly controlled at great expense. After manufacture, if significant communication errors occur in communications, manual testing can sometimes be conducted to determine how to correct the problem and if unacceptable impedance mismatches or electromagnetic interference are present in some circumstances manual tuning of the circuit/system can be performed. Such manual testing is very expensive and traditional test methods have several drawbacks because equipment is relatively expensive, it must be operated by a trained technician and must be regularly calibrated.

In one embodiment of the present disclosure, a method for improving communication between a transmitter and a receiver is disclosed. The method can include receiving a first signal having a first power level over a first path, receiving a second signal having a second power level over a second path wherein the first path is different than the second path. The method can compare the first power level with the second power and determine a difference between the first power level and the second power level. The method can also adjusting a parameter in the system to reduce the difference in power levels between the first and second signals compensating for interference cause by many sources.

In another embodiment an apparatus is disclosed that includes a first power detector to receive a transmission having a first power level, and a second power detector to receive a transmission having a second power level. In addition the apparatus can include a compare module to compare the first power level to the second power level and to determine a difference between the first power level and the second power level and an adjustment module to make a system adjustment to reduce the difference between the first and second power levels.

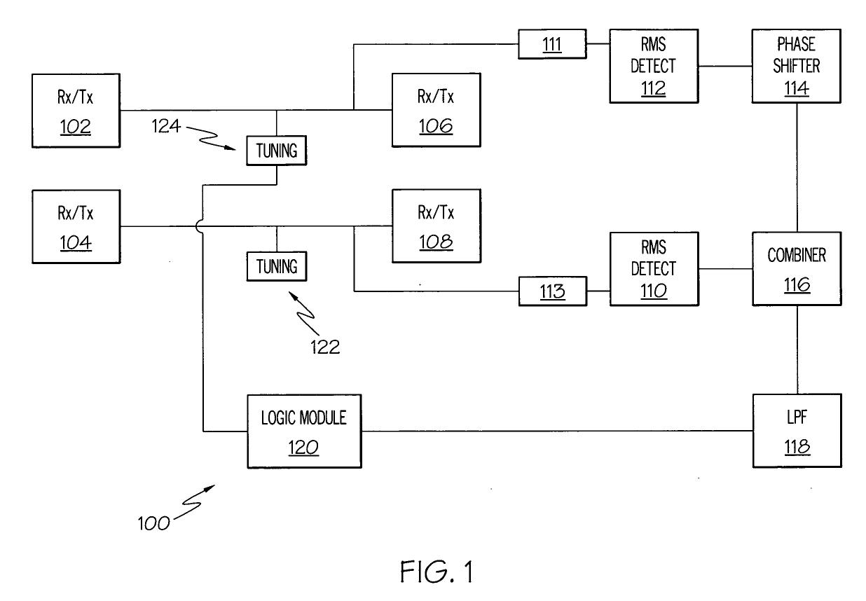

In FIG. 1 a transmission path monitoring system 100 having a differential transmission line is depicted. The system 100 can include a first transceiver 102 connected to a second transceiver 106 on a first part of a differential data transmission path. Third transceiver 104 can be connected to a fourth transceiver 108 on a second part of the differential transmission path. Such a differential transmission path is commonly found on circuit boards such as mother boards in computer systems.

In accordance with the present disclosure, the transmission path monitoring system 100 can include a filter 111 connected to a root mean square detector 112 that is connected to one side of the transmission line. Another filter 113 and root mean square detector 110 can be connected to the second side of the transmission line. The system 100 can also include a phase shifter 114, a combiner 116 and a low pass filter 118. The filters and (RMS) detectors 110, 111, 112, and 113 can detect a root mean square of the power level that is occurring on the transmission lines at a desired frequency. The power can be determined based on the energy produced by transmitted data. The tuning of the filters 111 and 113 can dictate at what frequency(ies) the power level will be measured.

One measured power level can be phase shifted one hundred and eighty degrees by phase shifter 116, and the phase shifter power level can be compared with the non-phase shifted power level. If the power levels are identical then there will be a very low level output or no detectable output out of the combiner 116 indicating that the transmission paths are matched which is a desirable situation.

If there is an impedance mismatch(es) on the transmission lines there will be different power levels present on the transmission lines during data transmissions and the output of the combiner 116 will provide an output signal representative of this impedance mismatch. This can be referred to as the skew that exists on the transmission lines.

The output of the combiner 116 can be filtered by a low pass filter 118 to remove or suppress higher frequency components to improve the accuracy of the power differential measurement that occurs on the transmission lines. A logic module 120 can take the power differential reading/measurement and adjust the skew that can occur by controlling tuning modules 124 and 122. The output of the combiner 116 can have a polarity that dictates which tuning module 124 or 124 should be provided with a control signals. The process can be iterative where the tuning modules are adjusted and then the power differential is again measure to see if an improvement has occurred. If a tuning correction degrades performance can be retracted and an adjustment can occur in a different direction.

The disclosed arrangement can significantly improve electromagnetic interference (EMI) issues due to asymmetry and mismatch in skew of high speed interconnects lines. Asymmetry can be defined as variation in a data sequences rise/fall time due to circuit or channel parasitics (capacitance/impedance) while skew can be characterized as the difference in interconnect line lengths due to manufacturing imperfections. The disclosed adaptive algorithm executed by the system 100 allows for implementation of circuit topologies “free” of design rules, (or having less design tolerances) and layout optimization and can rely on adaptive algorithms in order to dynamically monitor and adjust communication performance.

The disclosed arrangement can include two high speed interconnect conductor pairs, and a filter and RMS detector for each conductor. The filters 111 and 113 can be tuned to a center frequency of 1/T with T equal to I/O symbol rate. The RMS detectors 110 And 112 can be implemented as squaring (rectification) circuits to provided an output that corresponds to a variance of the filtered waveform over time. The tuners 122 and 124 can be implemented as adjustable banks of source capacitive load values and/or equalization coefficients controlled by the logic module 106 providing an algorithm-governed by a least mean square optimization criterion. Tuning modules 122 and 124 could be micro electro-mechanical devices, inductors or other adjustable impedance device. The disclosed LMS power algorithm utilized by the logic module 120 can seek to drive the difference in variance between the + and − lines to zero by adjustment of source load or equalization characteristics.

In one configuration the disclosed arrangements provide a closed loop algorithm to actively minimize EMI due to skew mismatch. In addition, the disclosed arrangements provide an adaptive adjustment technique that will allow for improved design cycle time, greater variability in I/O topologies, and improved yields in I/O configurations. With the disclosed arrangements a tight tolerance for matching of I/O skew may not be necessary when an initial design is created as with previous design systems. Design parameters/standards can be lowered because the disclosed system allows parameters to be monitored and adjusted dynamically after the system is fabricated. Therefore, reductions in engineering costs and improved fabrication yields can with implementation of the disclosed hardware and adaptive algorithm. In traditional designs, an “optimal” layout or design is created and replicated across multiple instantiations of I/O topologies. The disclosed post design adaptive arrangements allow for correcting design deficiencies.

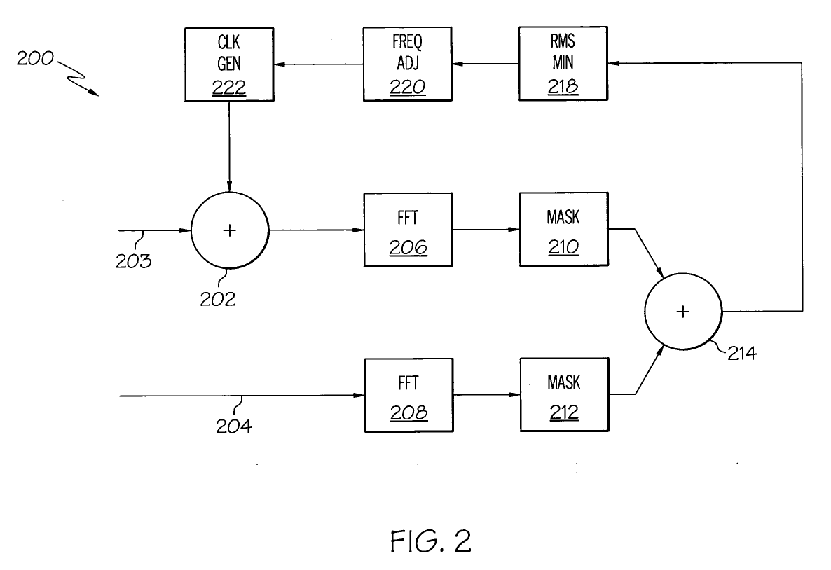

Referring to FIG. 2 another embodiment of a transmission path monitoring system is disclosed. The disclosed embodiment can detect a differential power occurring on two different wireless channels in a circuit where interference is introduced into one of the communication paths. Such introduction of interference is illustrated by coupler 202 which “couples in” a clock harmonic of clock generator 222. Thus, the addition of noise to the wireless path is not done intentionally but reflects a phenomenon that is common, where noise at a particular frequency couples into a transmission path causing undesirable interference adversely affecting system operation.

The system 200 can include two communication paths 203 and 204 that are connected to fast Fourier transform modules 206 and 208 and the outputs of the fast Fourier transform modules 206 and 208 can be fed into mask modules 210 and 212. The fast Fourier modules 206 and 208 can detect the power that exists on the wireless channels. Generally, the fast Fourier modules/engines 206 and 208 can translate received signals from time domain to frequency domain. In the frequency domain a mask can be applied to the received power spectral density and compared against an expected or predetermined value to determine if a mismatch has occurred. With the absence of any RFI, the expected value will be consistent. However, the introduction of RFI will result in an elevated expected value and therefore invoke an adaptive correction/mitigation state. The outputs of the masks 210 and 212 can be fed to a combiner 214 that can determine a power differential between the power present on the two transmission lines 203 and 204.

The output of the combiner 214 can provide a root mean square (RMS) power differential detector 218 which can determine if the RMS power differential between the power lines 203 and 204 is greater than a predetermined value and define the path that has a higher or lower power level. If the RMS power differential is over a predetermined value then a signal can be sent to a frequency adjustment module 220 which can adjust an oscillation frequency of the clock generator 222 such that reduced coupling will occur into the wireless channel/transmission path 203.

In one embodiment the clock generator 222 can be a clock within a circuit such as a phase locked loop or a voltage controlled oscillator. Specific frequencies of the clock generator may couple into the transmission path with greater ease and changing the oscillating frequency of clock generator generating noise can change the coupling efficiency between the clock generator 222 and the transmission path 203. As the frequency of clock generator 222 is changed the coupling of the detected frequency can be reduced and the system 200 can again recheck the amount of coupling. As can be appreciated, the clock generator 222 may only be allowed to change within specific limits to allow the system 200 to operate acceptably.

The disclosed arrangement can significantly improve the wireless radio performance in a digital platform by providing an adaptable algorithm that dynamically monitors a wireless channel and optimizes it by adjusting relevant phase locked loops (PLLs) in order to minimize internally generated radio frequency interference (RFI). The disclosed arrangement will allow for efficient wireless interconnectivity of any wireless platforms by reducing internal interference via frequency adjustment of offending PLL. Such a configuration can increase overall platform wireless throughput and range via reduction of desense due to interference.

Many wireless radio receivers that are capable of tuning to independent wireless channels can utilize the disclosed concepts. Multi-carrier based, but not limited to, wireless communication systems based on fast Fourier transforms can utilize this disclosed concept. Multiple interference penalty profiles can be determined that are related to expected received wireless protocol. Such profiles can have specific spectral content.

With input from the RMS module 218 the frequency adjustment module 220 can perform as a computing clock management engine capable of providing an adjustment signal based on receipt of frequency adjustment information and from the RMS module. The frequency adjustment engine 220 can have the capability to dynamically adjust a platform or PLL (clock) base frequency or spread spectrum modulation rate to minimize the interference that occurs over a channel.

The system 200 can provide a closed loop algorithm that utilizes existing detection capability of the wireless platform radios and adjustment of computing base clock frequencies or spreading factors, via weighted cost function, and via a minimum mean square driven cost function. Traditionally, in-band spurious emissions can be left for adjustment/optimization after the design and development cycle. Such adjustment may be needed for example to obtain approval from the Federal Communication Commission.

This disclosed system can dynamically monitor an affected wireless channels and optimize these channels for minimal radio frequency interference (RFI) impact via a least mean square (LMS) algorithm. The desired on-channel+interference can be detected by existing wireless receiver (path 203) and compared against an ideal channel (path 204), known to be free of interference. This information can be utilized by a platform management engine (220 and 218) to either shift the offending computing clock's center frequency or spread clock percentage, if applicable. The end result will be a shift of the interference clock to a “neutral” or less invasive position adaptively determined when a minimum value is achieved via the equation: |RMS1−RMS2|, at module 218 where the RMS values represent (FFT×Mask).

The disclosed arrangement will allow for both minimal adjustment of PLL (clock) frequency (glide) rate changes while achieving maximum benefit in RF interference mitigation for a desired wireless channel. As stated above, this disclosed arrangement allows for real-time/post development of environmental or internal platform noise impacts, thus minimizing return of material (platforms), maximum wireless platform performance, and improved platform noise/interference. The disclosed arrangement can utilize multiple receivers and platform electromagnetic interference (EMI) mitigation for the improvement of wireless platform performance. The disclosed arrangement can establish high performance benchmarks for wireless platforms.

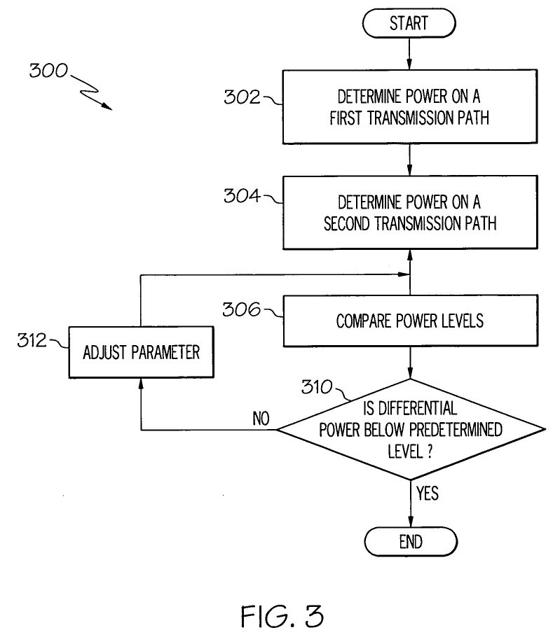

Referring to FIG. 3 a method 300 for adjusting transmission line parameters is disclosed. A first signal having a first power level can be received over a first transmission path as illustrated by block 302. A second signal having a second power level can be received over a second transmission path as illustrated by block 304. The term signal is utilized to describe any electromagnetic energy that could be received. The power levels of the first and second signals can be compared, as illustrated in block 306.

As illustrated by decision block 310, it can be determined if the power differential is below a predetermined level. If the power level is acceptable the process can end. If the power differential is above a predetermined level then parameters in the system can be adjusted as illustrated in block 312. Adjusting the parameters can include changing a clock frequencies, change in an impedance on the power lines etc. During subsequent transmissions it can again be determined if the power differential level is within a predetermined specification in an iterative process. An adjustment module can continuously change parameters in an attempt to optimize the communication performance based on cost functions that can be monitored after parameters are changed. When the adjustment has been made such that the power differential is minimized the process can end.

Each process disclosed herein can be implemented with a software program. The software programs described herein may be operated on any type of computer, such as personal computer, server, etc. Any programs may be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet, intranet or other networks. Such signal-bearing media, when carrying computer-readable instructions that direct the functions of the present disclosure, represent embodiments of the present disclosure.

The disclosed embodiments can take the form of an entirely hardware embodiment, an entirely software embodiment or an embodiment containing both hardware and software elements. In one embodiment, the arrangements can be implemented in software, which includes but is not limited to firmware, resident software, microcode, etc. Furthermore, the disclosure can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The control module can retrieve instructions from an electronic storage medium. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. A data processing system suitable for storing and/or executing program code can include at least one processor, logic, or a state machine coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

It will be apparent to those skilled in the art having the benefit of this disclosure that the present disclosure contemplates methods, systems, and media that can automatically tune a transmission line. It is understood that the form of the arrangements shown and described in the detailed description and the drawings are to be taken merely as examples. It is intended that the following claims be interpreted broadly to embrace all the variations of the example embodiments disclosed.

What is claimed is:

1. A method comprising:
receiving a first signal having a first power level over a first path;
receiving a second signal having a second power level over a second path wherein the first path is different than the second path;
comparing the first power level with the second power;
determining a difference between the first power level and the second power level; and
adjusting a parameter in the system to reduce the difference in power levels between the first and second signals.

2. The method of claim 1, further comprising performing a fast Fourier transform on the first and second received signals.

3. The method of claim 1, further comprising masking the first and second determined power levels.

4. The method of claim 1, wherein the transmission path is wireless path.

5. The method of claim 1, wherein determining comprises determining a root means square of the first and second received signals.

6. The method of claim 1, wherein the transmission path is a physical conductor.

7. The method of claim 1, wherein the parameter is a frequency adjustment.

8. The method of claim 1, wherein the parameter is an impedance.

9. An apparatus comprising:
a first power detector to receive a transmission having a first power level;
a second power detector to receive a transmission having a second power level, the second power level being different than the first power level;
a compare module to compare the first power level to the second power level and to determine a difference between the first power level and the second power level; and
an adjustment module to make a system adjustment to reduce the difference between the first and second power levels.

10. The apparatus of claim 9, further comprising a filter to filter at least one frequency of the transmission.

11. The apparatus of claim 9, wherein the first and second power detector comprise a root mean square detector.

12. The apparatus of claim 9, further comprising a phase shifter to shift a phase of one of the first or second power level.

13. The apparatus of claim 9, further comprising a fast Fourier transform module and a mask to detect a power level.

14. The apparatus of claim 9, wherein the adjustment module is one of an impedance tuning module or a frequency adjustment module.

15. The apparatus of claim 9, wherein the adjustment module provides continuous optimization based on monitoring at least one cost function.
